(19) United States
(12) Patent Application Publication
(10) Pub. No.: US 2020/0401665 A1
(43) Pub. Date: Dec. 24, 2020

(54) STORAGE MANAGEMENT SYSTEM AND METHOD

(71) Applicant: EMC IP Holding Company LLC, Hopkinton, MA (US)

(72) Inventor: Assaf Natanzon, Tel Aviv (IL)

(21) Appl. No.: 15/274,617

(22) Filed: Sep. 23, 2016

(51) Int. Cl. G06F 17/30; H04L 29/08

(52) U.S. Cl. CPC G06F 17/30575; H04L 67/1095

(57) ABSTRACT

A method, computer program product, and computing system for maintaining an application-layer, active-active relationship between a first site and a second site within a storage system during a normal operation mode. Determining if the storage system enters a degraded mode due to the first site of the storage system going offline. In response to entering the degraded mode, write requests and read requests are processed on the second site. Determining if the storage system enters a resynchronization mode due to the first site of the storage system returning online. In response to entering the resynchronization mode, a block-layer, active-active relationship is maintained between the first site and the second site within the storage system.

### TECHNICAL FIELD

This disclosure relates to storage systems and, more particularly, to RAID-based storage systems.

### BACKGROUND

Storing and safeguarding electronic content is of paramount importance in modern business. Accordingly, various methodologies may be employed to protect such electronic content. Examples of such methodologies may include configuring an active-active storage system, wherein the application and the electronic content is available at multiple sites for redundant purposes. Unfortunately, even redundant sites within an active-active storage system will eventually fail and will need to be resynchronized.

### SUMMARY OF DISCLOSURE

In one implementation, a computer-implemented method is executed on a computing device and includes maintaining an application-layer, active-active relationship between a first site and a second site within a storage system during a normal operation mode. Determining if the storage system enters a degraded mode due to the first site of the storage system going offline. In response to entering the degraded mode, write requests and read requests are processed on the second site. Determining if the storage system enters a resynchronization mode due to the first site of the storage system returning online. In response to entering the resynchronization mode, a block-layer, active-active relationship is maintained between the first site and the second site within the storage system.

One or more of the following features may be included. A determination may be made concerning whether the storage system reenters the normal mode due to the first site being resynchronized with the second site of the storage system. In response to reentering the normal mode, the block-layer, active-active relationship may be ended between the first site and the second site within the storage system. Maintaining an application-layer, active-active relationship between a first site and a second site within a storage system may include: mirroring a request received on the first site to the second site; and processing the request received on the first site on both the first site and the second site. Maintaining an application-layer, active-active relationship between a first site and a second site within a storage system may include: mirroring a request received on the second site to the first site; and processing the request received on the second site on both the first site and the second site. The first site of the storage system may go offline due to one or more of: a hardware failure; and a software failure. Maintaining a block-layer, active-active relationship between the first site and the second site within the storage system may include: processing read requests received by the first site on the first site; and processing read requests received by the second site on the second site. Maintaining a block-layer, active-active relationship between the first site and the second site within the storage system may include: processing write requests received by the first site on the second site; and processing write requests received by the second site on the second site. Maintaining an application-layer, active-active relationship between a first site and a second site within a storage system may include executing a file system and processing one or more file system commands chosen from the group consisting of: a create file command, a delete file command, a rename file command and a truncate file command. Maintaining an application-layer, active-active relationship between a first site and a second site within a storage system may include executing a database and processing one or more database commands including a SQL command.

In another implementation, a computer program product resides on a computer readable medium and has a plurality of instructions stored on it. When executed by a processor, the instructions cause the processor to perform operations including maintaining an application-layer, active-active relationship between a first site and a second site within a storage system during a normal operation mode. Determining if the storage system enters a degraded mode due to the first site of the storage system going offline. In response to entering the degraded mode, write requests and read requests are processed on the second site. Determining if the storage system enters a resynchronization mode due to the first site of the storage system returning online. In response to entering the resynchronization mode, a block-layer, active-active relationship is maintained between the first site and the second site within the storage system.

One or more of the following features may be included. A determination may be made concerning whether the storage system reenters the normal mode due to the first site being resynchronized with the second site of the storage system. In response to reentering the normal mode, the block-layer, active-active relationship may be ended between the first site and the second site within the storage system. Maintaining an application-layer, active-active relationship between a first site and a second site within a storage system may include: mirroring a request received on the first site to the second site; and processing the request received on the first site on both the first site and the second site. Maintaining an application-layer, active-active relationship between a first site and a second site within a storage system may include: mirroring a request received on the second site to the first site; and processing the request received on the second site on both the first site and the second site. The first site of the storage system may go offline due to one or more of: a hardware failure; and a software failure. Maintaining a block-layer, active-active relationship between the first site and the second site within the storage system may include: processing read requests received by the first site on the first site; and processing read requests received by the second site on the second site. Maintaining a block-layer, active-active relationship between the first site and the second site within the storage system may include: processing write requests received by the first site on the second site; and processing write requests received by the second site on the second site. Maintaining an application-layer, active-active relationship between a first site and a second site within a storage system may include executing a file system and processing one or more file system commands chosen from the group consisting of: a create file command, a delete file command, a rename file command and a truncate file command. Maintaining an application-layer, active-active relationship between a first site and a second site within a storage system may include executing a database and processing one or more database commands including a SQL command.

In another implementation, a computing system including a processor and memory is configured to perform operations including maintaining an application-layer, active-active relationship between a first site and a second site within a storage system during a normal operation mode. Determining if the storage system enters a degraded mode due to the first site of the storage system going offline. In response to entering the degraded mode, write requests and read requests are processed on the second site. Determining if the storage system enters a resynchronization mode due to the first site of the storage system returning online. In response to entering the resynchronization mode, a block-layer, active-active relationship is maintained between the first site and the second site within the storage system.

One or more of the following features may be included. A determination may be made concerning whether the storage system reenters the normal mode due to the first site being resynchronized with the second site of the storage system. In response to reentering the normal mode, the block-layer, active-active relationship may be ended between the first site and the second site within the storage system. Maintaining an application-layer, active-active relationship between a first site and a second site within a storage system may include: mirroring a request received on the first site to the second site; and processing the request received on the first site on both the first site and the second site. Maintaining an application-layer, active-active relationship between a first site and a second site within a storage system may include: mirroring a request received on the second site to the first site; and processing the request received on the second site on both the first site and the second site. The first site of the storage system may go offline due to one or more of: a hardware failure; and a software failure. Maintaining a block-layer, active-active relationship between the first site and the second site within the storage system may include: processing read requests received by the first site on the first site; and processing read requests received by the second site on the second site. Maintaining a block-layer, active-active relationship between the first site and the second site within the storage system may include: processing write requests received by the first site on the second site; and processing write requests received by the second site on the second site. Maintaining an application-layer, active-active relationship between a first site and a second site within a storage system may include executing a file system and processing one or more file system commands chosen from the group consisting of: a create file command, a delete file command, a rename file command and a truncate file command. Maintaining an application-layer, active-active relationship between a first site and a second site within a storage system may include executing a database and processing one or more database commands including a SQL command.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a storage system and a storage management process coupled to a distributed computing network;

FIG. 2 is a diagrammatic view of the storage system of FIG. 1;

FIG. 3 is a diagrammatic view of another embodiment of the storage system of FIG. 1; and

FIG. 4 is a flow chart of the storage management process of FIG. 1.

Like reference symbols in the various drawings indicate like elements.

### DETAILED DESCRIPTION OF THE PREFERRED EMBODIMENTS

### System Overview:

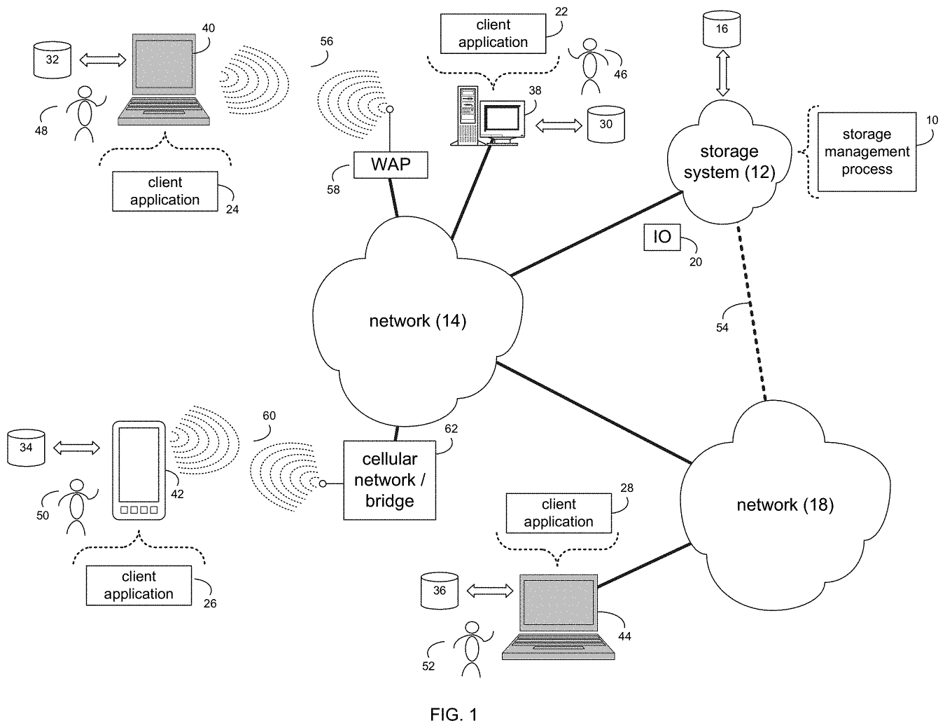

Referring to FIG. 1, there is shown storage management process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft Windows Server™; Redhat Linux™, Unix, or a custom operating system, for example.

The instruction sets and subroutines of storage management process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (i.e. a request that content be written to storage system 12) and data read requests (i.e. a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices (e.g., client electronic devices 38, 40, 42, 44) may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft Windows™, Apple Macintosh™, Redhat Linux™, or a custom operating system.

For illustrative purposes, storage system 12 will be described as being a network-based storage system that includes a plurality of backend storage devices. However, this is for illustrative purposes only and is not intended to be a limitation of this disclosure, as other configurations are possible and are considered to be within the scope of this disclosure.

### Storage System:

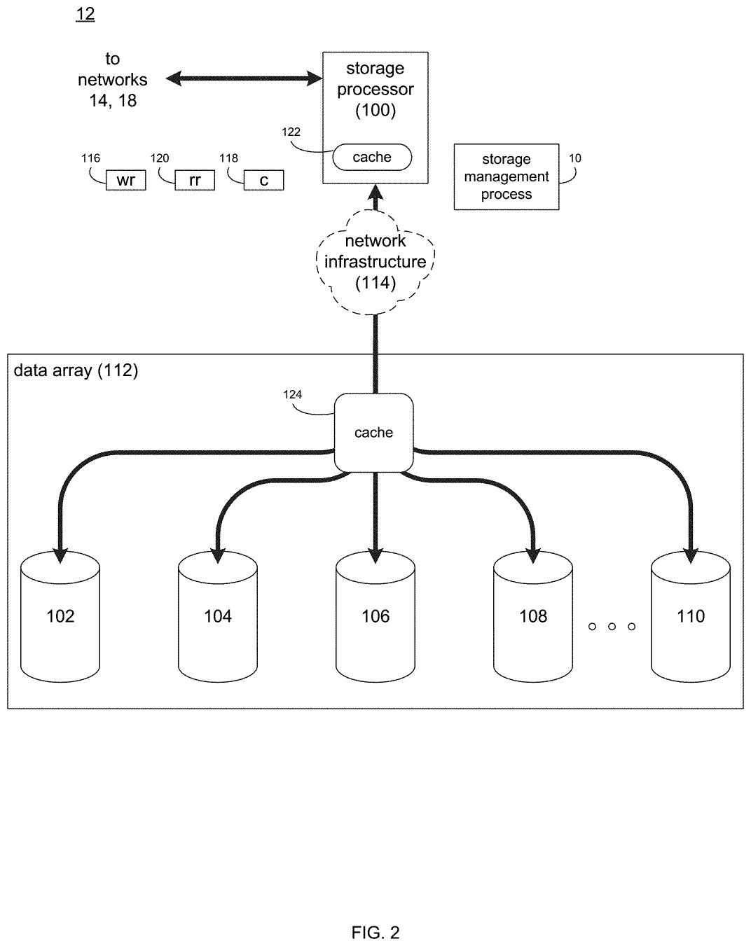

Referring also to FIG. 2, there is shown a general implementation of storage system 12. In this general implementation, storage system 12 may include storage processor 100 and a plurality of storage targets (e.g. storage targets 102, 104, 106, 108, 110). Storage targets 102, 104, 106, 108, 110 may be configured to provide various levels of performance and/or high availability. For example, one or more of storage targets 102, 104, 106, 108, 110 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108, 110 may be configured as a RAID 1 array, in which data is mirrored between storage targets. By mirroring data between storage targets, a level of high availability is achieved as multiple copies of the data are stored within storage system 12.

While storage targets 102, 104, 106, 108, 110 are discussed above as being configured in a RAID 0 or RAID 1 array, this is for illustrative purposes only and is not intended to be a limitation of this disclosure, as other configurations are possible. For example, storage targets 102, 104, 106, 108, 110 may be configured as a RAID 3, RAID 4, RAID 5, RAID 6 or RAID 7 array.

While in this particular example, storage system 12 is shown to include five storage targets (e.g. storage targets 102, 104, 106, 108, 110), this is for illustrative purposes only and is not intended to be a limitation of this disclosure. Specifically, the actual number of storage targets may be increased or decreased depending upon e.g. the level of redundancy/performance/capacity required.

One or more of storage targets 102, 104, 106, 108, 110 may be configured to store coded data, wherein such coded data may allow for the regeneration of data lost/corrupted on one or more of storage targets 102, 104, 106, 108, 110. Examples of such coded data may include but is not limited to parity data and Reed-Solomon data. Such coded data may be distributed across all of storage targets 102, 104, 106, 108, 110 or may be stored within a specific storage device.

Examples of storage targets 102, 104, 106, 108, 110 may include one or more electro-mechanical hard disk drives and/or solid-state/flash devices, wherein a combination of storage targets 102, 104, 106, 108, 110 and processing/control systems (not shown) may form data array 112.

The manner in which storage system 12 is implemented may vary depending upon e.g. the level of redundancy/performance/capacity required. For example, storage system 12 may be a RAID device in which storage processor 100 is a RAID controller card and storage targets 102, 104, 106, 108, 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108, 110 may be a RAID device and/or computer-based hard disk drives. Further still, one or more of storage targets 102, 104, 106, 108, 110 may be a SAN.

In the event that storage system 12 is configured as a SAN, the various components of storage system 12 (e.g. storage processor 100, storage targets 102, 104, 106, 108, 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of storage management process 10. The instruction sets and subroutines of storage management process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random access memory (RAM); a read-only memory (ROM); and all forms of flash memory storage devices.

As discussed above, various IO requests (e.g. IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (i.e. a request that content 118 be written to storage system 12) and data read request 120 (i.e. a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g. one or more of storage targets 102, 104, 106, 108, 110.

As discussed above, the instruction sets and subroutines of storage management process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of storage management process 10 may be executed by one or more processors (not shown) and one or more memory architectures (not shown) included within data array 112.

### The Storage Management Process:

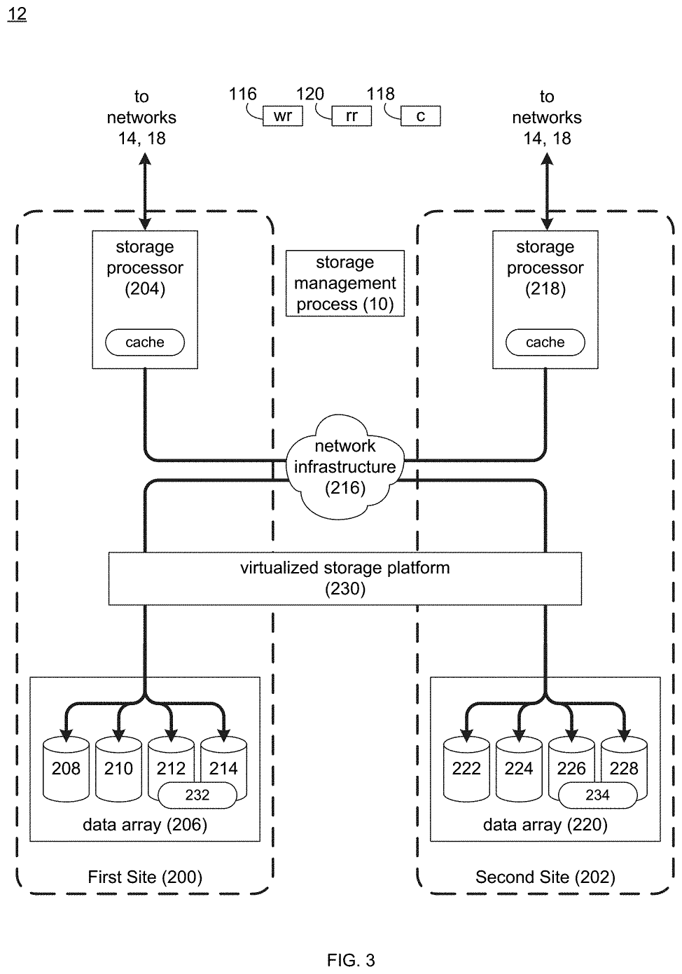

Referring also to FIG. 3, there is shown another implementation of storage system 12, which is shown in an active-active configuration. In this particular configuration, storage system 12 is shown to include two sites, namely first site 200 and second site 202. When configured in an active-active configuration, either site (e.g., first site 200 or second site 202) or both sites (e.g., first site 200 and second site 202) may be configured to process read requests and write requests in a manner so that any data stored within first site 200 and second site 202 is identical.

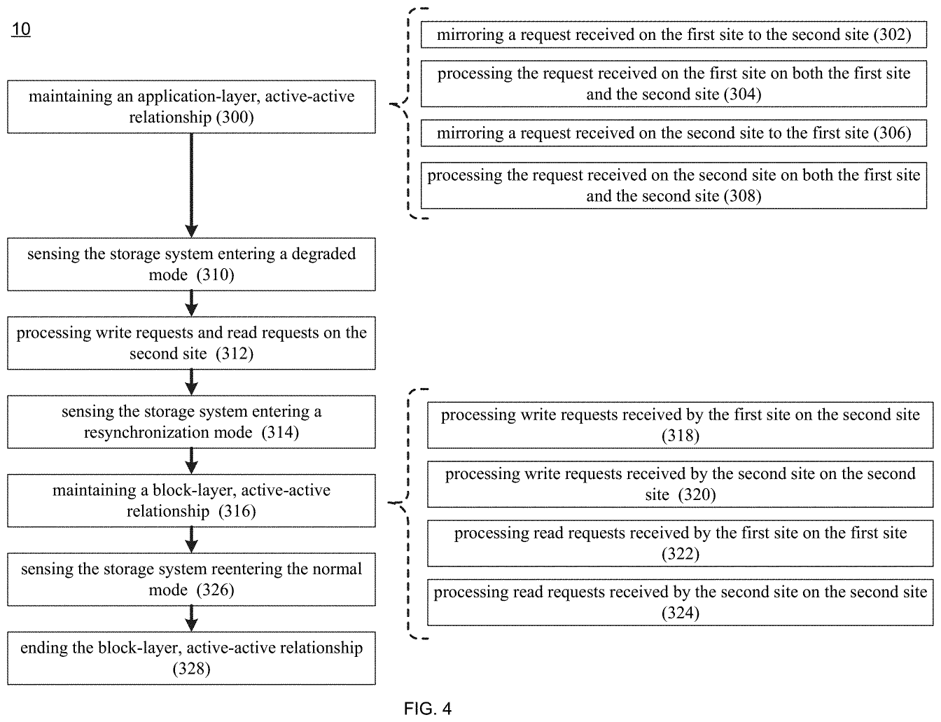

Accordingly and referring also to FIG. 4, storage management process 10 may maintain 300 an application-layer, active-active relationship between first site 200 and second site 202 within storage system 12 during a normal operation mode. During such normal operation mode, data write requests 116 and/or data read requests 120 may be processed.

As discussed above, various IO requests (e.g. data write requests 116 and/or data read requests 120) may be generated. For example, these IO requests (e.g. data write requests 116 and/or data read requests 120) may be sent from client applications 22, 24, 26, 28 to storage system 12. Additionally/alternatively and when configured as an application server, IO requests (e.g. data write requests 116 and/or data read requests 120) may be internally generated within e.g., a storage processor within storage system 12. Further and when configured in an active-active fashion in the application layer, the commands being mirrored may not necessarily be IO requests (e.g. data write requests 116 and/or data read requests 120) and may include application specific commands. If the application being executed is a file system, the commands processed may include but are not limited to a create file command, a delete file command, a rename file command and a truncate file command. If the application being executed is a database, the command processed may include but are not limited to a SQL command, such as a select and create new table command (which may translate to millions of discrete storage commands).

As discussed above and in this particular embodiment, storage system 12 is shown to include first site 200 and second site 202. First site 200 is shown to include storage processor 204 and data array 206, wherein data array 206 is shown to include four storage targets (namely storage targets 208, 210, 212, 214). In this particular example, storage processor 204 is coupled to data array 206 via network infrastructure 216. Second site 202 is shown to include storage processor 218 and data array 220, wherein data array 220 is shown to include four storage targets (namely storage targets 222, 224, 226, 228). In this particular example, storage processor 218 is also coupled to data array 220 via network infrastructure 216.

While in the above-stated example, first site 200 and second site 202 are each shown to each include a separate and distinct data array (data array 206 and data array 220 respectively), this is for illustrative purposes only and is not intended to be a limitation of this disclosure, as other configurations are possible and are considered to be within the scope of this disclosure. For example, first site 200 and second site 202 may share a common data array and e.g., write their data to distinct LUNs (i.e., logical units) on the common data array.

While in the above-stated example, data array 206 and data array 220 are each shown to include four storage targets (storage targets 208, 210, 212, 214 and storage targets 222, 224, 226, 228 respectively), this is for illustrative purposes only and is not intended to be a limitation of this disclosure, as other configurations are possible and are considered to be within the scope of this disclosure. For example, the number of storage targets included within data array 206 and/or data array 220 may be increased or decreased depending upon need.

During normal operation mode, various clients (e.g., client applications 22, 24, 26, 28) may read data from and/or write data to either or both of first site 200 and second site 202, wherein active-active storage system 12 may be configured to ensure that the data within data array 206 and data array 220 are maintained in identical states. In order to achieve this, IO requests provided to (or generated by) storage system 12 may be intercepted and mirrored between first site 200 and second site 202.

Accordingly and when maintaining 300 the application-layer, active-active relationship between first site 200 and second site 202 within storage system 12, storage management process 10 may mirror 302 a request (e.g. data write request 116 and/or data read request 120) received on first site 200 to second site 202; and may process 304 the request (e.g. data write request 116 and/or data read request 120) received on first site 200 on both first site 200 and second site 202. As discussed above and when configured in an active-active fashion in the application layer, the commands being mirrored may not necessarily be TO requests (e.g. data write requests 116 and/or data read requests 120) and may include application specific commands that may be considerably complex (e.g., a SQL command that performs many reads and writes to the backend).

Conversely and when maintaining 300 the application-layer, active-active relationship between first site 200 and second site 202 within storage system 12, storage management process 10 may mirror 306 a request (e.g. data write request 116 and/or data read request 120) received on second site 202 to first site 200; and may process 308 the request (e.g. data write request 116 and/or data read request 120) received on second site 202 on both first site 200 and second site 202.

For example, if data write request 116 (concerning the writing of content 118) is received by first site 200, data write request 116 may be mirrored 302 to second site 202 so that both first site 200 and second site 202 may process 304 data write request 116 and, therefore, write content 118 to data array 206 and data array 220 (respectively). Again, these examples are intended to be illustrative only and it is understood that complex application commands may also be mirrored and processed (which may result in the execution of e.g., millions of discrete read operations and/or write operations on the backend storage).

Concerning read request 120, since the data stored within data array 206 and data array 220 is identical (for the reasons discussed above), either of first site 200 and second site 202 may process data read request 120. Accordingly, the mirroring of data read requests may not be needed/required. However, a higher level of performance may be realized by mirroring data read requests between first site 200 and second site 202. Specifically, by mirroring data read requests between first site 200 and second site 202 and having both of sites 200, 202 process data read request 120, the faster of sites 200, 202 will always provide the requested data first, thus ensuring a higher level of performance, wherein the data provided by the later-responding site could simply be ignored. Additionally/alternatively, reads request may be processed on the geographically closer site.

Storage management process 10 may monitor storage system 12 to sense 310 storage system 12 entering a degraded mode due to e.g., a failure of one of the sites included within storage system 12. For example, assume that storage management process 10 senses 310 storage system 12 entering a degraded mode due to e.g., first site 200 of storage system 12 going offline. First site 200 of storage system 12 may have gone offline due to a hardware failure (e.g., a failure of storage processor 204) and/or a software failure (e.g., a failure of an application, such as a database program. executed on data first site 200).

In response to entering this degraded mode due to e.g., first site 200 going offline, storage management process 10 may process 312 all write requests (e.g., data write request 116) and all read requests (e.g., data read request 120) on second site 202 (e.g., as second site 202 is the only site available). Unfortunately, while (in this example) second site 202 is available to process all IO requests, whenever a data write request is processed and content (e.g., content 118) is written to (in this example) data array 220, data array 220 will become more out of sync with data array 206 within first site 200 (as first site 200 is offline).

Storage management process 10 may continue to monitor storage system 12 to sense 314 storage system 12 entering a resynchronization mode due to first site 200 of storage system 12 returning online. For example, if first site 200 went offline because of a failure of storage target 208 and data array 206 includes a “hot spare” storage target (not shown), storage management process 10 may automatically repair data array 206 by swapping out failed storage target 208 with the hot spare (not shown) and first site 200 of storage system 12 may return to online status. However and as discussed above, data array 206 will be out of sync with data array 220, as data was written to data array 220 while first site 200 (and data array 206) was offline.

In response to entering the resynchronization mode, storage management process 10 may maintain 316 a block-layer, active-active relationship between first site 200 and second site 202 within storage system 12. Continuing with the above-stated example, this block-layer, active-active relationship between first site 200 and second site 202 may allow for the rebuilding of first site 200 from second site 202 at the block level. Specifically and since data array 220 and second site 202 represent the current version of the data stored within storage system 12, the content within data array 220 of second site 202 may be copied/used to rebuild data array 206 within first site 200. In order to effectuate such a block-layer rebuilding of data array 206 within first site 200, a virtualized storage platform (e.g., virtualized storage platform 230) may be initiated/effectuated. An example of such virtualized storage platform 230 may include but is not limited to VPLEX, which is a virtual computer data storage software product offered by the EMC Corporation of Hopkinton, Mass.

When maintaining 316 a block-layer, active-active relationship between first site 200 and second site 202 within storage system 12, storage management process 10 may process 318 write requests (e.g., write request 116) received by first site 200 on second site 202; and may process 320 write requests (e.g., write request 116) received by second site 202 on second site 202. Specifically, the write requests (e.g., write request 116) are intercepted and redirected to the site that did not fail and has the current version of the data stored on it. Accordingly and in this example, write requests (e.g., write request 116) destined for first site 200 (the site that is being resynchronized) are intercepted and redirected to second site 202 so that they may be processed 318. Conversely and in this example, write requests (e.g., write request 116) destined for second site 202 (the site that never went down) are processed 320 on second site 202.

When maintaining 316 a block-layer, active-active relationship between first site 200 and second site 202 within storage system 12, storage management process 10 may process 322 read requests (e.g., read request 120) received by first site 200 on first site 200; and may process 324 read requests (e.g., read request 120) received by second site 202 on second site 202. Accordingly and during resynchronization mode, read requests (e.g., read request 120) may be processed by the site that receives the request.

In order to ensure that, in response to a read request (e.g., read request 120), the most current version of the data is provided to the requestor, virtualized storage platform 230 may expose a LUN (i.e., logical unit) to each of first site 200 and second site 202. For example, LUN 232 may be exposed as a storage target within first site 200 and LUN 234 may be exposed as a storage target within second site 202. Specifically and being that LUNs 232, 234 are virtualized, virtualized storage platform 230 may ensure that the LUNS appear identical to both first site 200 and second site 202, even though the actual content within data array 206 and data array 220 may be dissimilar.

Storage management process 10 may continue to monitor storage system 12 to sense 326 storage system 12 reentering the normal mode due to first site 200 being resynchronized with second site 202 of storage system 12. In response to reentering the normal mode, storage management process 10 may end 328 the block-layer, active-active relationship between first site 200 and second site 202 within storage system 12. Accordingly, storage system 12 will once again return to having only a single layer of active-active relationships, namely at the application level.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

1. A computer-implemented method, executed on a computing device, comprising:
maintaining an application-layer, active-active relationship between a first site and a second site within a storage system during a normal operation mode;
sensing the storage system entering a degraded mode due to the first site of the storage system going offline;
in response to entering the degraded mode, processing write requests and read requests on the second site;
sensing the storage system entering a resynchronization mode due to the first site of the storage system returning online; and
in response to entering the resynchronization mode, maintaining a block-layer, active-active relationship between the first site and the second site within the storage system, wherein maintaining a block-layer active-active relationship includes:
intercepting write requests directed to the first site and redirecting those requests to the second site for processing on the second site only while the first site is being resynchronized,
exposing, via a virtualized storage platform, a logical unit as a storage target within each of the first site and the second site, wherein each logical unit is configured to appear identical to both the first site and the second site, and
providing, in response to a read request, a most current version of the data from one of the logical units of the first site and the second site.

2. The computer-implemented method of claim 1 further comprising:
sensing the storage system reentering the normal mode due to the first site being resynchronized with the second site of the storage system; and
in response to reentering the normal mode, ending the block-layer, active-active relationship between the first site and the second site within the storage system.

3. The computer-implemented method of claim 1 wherein maintaining an application-layer, active-active relationship between a first site and a second site within a storage system includes:
mirroring a request received on the first site to the second site; and
processing the request received on the first site on both the first site and the second site.

4. The computer-implemented method of claim 1 wherein maintaining an application-layer, active-active relationship between a first site and a second site within a storage system includes:
mirroring a request received on the second site to the first site; and
processing the request received on the second site on both the first site and the second site.

5. The computer-implemented method of claim 1 wherein the first site of the storage system goes offline due to one or more of:
a hardware failure; and
a software failure.

6. The computer-implemented method of claim 1 wherein maintaining a block-layer, active-active relationship between the first site and the second site within the storage system includes:
processing read requests received by the first site on the first site; and
processing read requests received by the second site on the second site.

7. The computer-implemented method of claim 6 wherein maintaining a block-layer, active-active relationship between the first site and the second site within the storage system includes:
processing write requests received by the first site on the second site; and
processing write requests received by the second site on the second site.

8. The computer-implemented method of claim 1 wherein maintaining an application-layer, active-active relationship between a first site and a second site within a storage system includes:
executing a file system; and
processing one or more file system commands chosen from the group consisting of: a create file command, a delete file command, a rename file command and a truncate file command.

9. The computer-implemented method of claim 1 wherein maintaining an application-layer, active-active relationship between a first site and a second site within a storage system includes:
executing a database; and
processing one or more database commands including a SQL command.

10. A computer program product residing on a non-transitory computer readable medium having a plurality of instructions stored thereon which, when executed by a processor, cause the processor to perform operations comprising:
maintaining an application-layer, active-active relationship between a first site and a second site within a storage system during a normal operation mode;
sensing the storage system entering a degraded mode due to the first site of the storage system going offline;
in response to entering the degraded mode, processing write requests and read requests on the second site;
sensing the storage system entering a resynchronization mode due to the first site of the storage system returning online; and
in response to entering the resynchronization mode, maintaining a block-layer, active-active relationship between the first site and the second site within the storage system, wherein maintaining a block-layer active-active relationship includes:
intercepting write requests directed to the first site and redirecting those requests to the second site for processing on the second site only while the first site is being resynchronized,
exposing, via a virtualized storage platform, a logical unit as a storage target within each of the first site and the second site, wherein each logical unit is configured to appear identical to both the first site and the second site, and
providing, in response to a read request, a most current version of the data from one of the logical units of the first site and the second site.

11. The computer program product of claim 10 further comprising instructions for:
sensing the storage system reentering the normal mode due to the first site being resynchronized with the second site of the storage system; and
in response to reentering the normal mode, ending the block-layer, active-active relationship between the first site and the second site within the storage system.

12. The computer program product of claim 10 wherein maintaining an application-layer, active-active relationship between a first site and a second site within a storage system includes:
mirroring a request received on the first site to the second site; and
processing the request received on the first site on both the first site and the second site.

13. The computer program product of claim 10 wherein maintaining an application-layer, active-active relationship between a first site and a second site within a storage system includes:
mirroring a request received on the second site to the first site; and
processing the request received on the second site on both the first site and the second site.

14. The computer program product of claim 10 wherein the first site of the storage system goes offline due to one or more of:
a hardware failure; and
a software failure.

15. The computer program product of claim 10 wherein maintaining a block-layer, active-active relationship between the first site and the second site within the storage system includes:
processing read requests received by the first site on the first site; and
processing read requests received by the second site on the second site.

16. The computer program product of claim 15 wherein maintaining a block-layer, active-active relationship between the first site and the second site within the storage system includes:
processing write requests received by the first site on the second site; and
processing write requests received by the second site on the second site.

17. The computer program product of claim 10 wherein maintaining an application-layer, active-active relationship between a first site and a second site within a storage system includes:
executing a file system; and
processing one or more file system commands chosen from the group consisting of: a create file command, a delete file command, a rename file command and a truncate file command.

18. The computer program product of claim 10 wherein maintaining an application-layer, active-active relationship between a first site and a second site within a storage system includes:
executing a database; and
processing one or more database commands including a SQL command.

19. A computing system including a processor and memory configured to perform operations comprising:
maintaining an application-layer, active-active relationship between a first site and a second site within a storage system during a normal operation mode;
sensing the storage system entering a degraded mode due to the first site of the storage system going offline;
in response to entering the degraded mode, processing write requests and read requests on the second site;
sensing the storage system entering a resynchronization mode due to the first site of the storage system returning online; and
in response to entering the resynchronization mode, maintaining a block-layer, active-active relationship between the first site and the second site within the storage system, wherein maintaining a block-layer active-active relationship includes:
intercepting write requests directed to the first site and redirecting those requests to the second site for processing on the second site only while the first site is being resynchronized,
exposing, via a virtualized storage platform, a logical unit as a storage target within each of the first site and the second site, wherein each logical unit is configured to appear identical to both the first site and the second site, and
providing, in response to a read request, a most current version of the data from one of the logical units of the first site and the second site.

20. The computing system of claim 19 further configured to perform operations comprising:
sensing the storage system reentering the normal mode due to the first site being resynchronized with the second site of the storage system; and
in response to reentering the normal mode, ending the block-layer, active-active relationship between the first site and the second site within the storage system.

21. The computing system of claim 19 wherein maintaining an application-layer, active-active relationship between a first site and a second site within a storage system includes:
mirroring a request received on the first site to the second site; and
processing the request received on the first site on both the first site and the second site.

22. The computing system of claim 19 wherein maintaining an application-layer, active-active relationship between a first site and a second site within a storage system includes:
mirroring a request received on the second site to the first site; and
processing the request received on the second site on both the first site and the second site.

23. The computing system of claim 19 wherein the first site of the storage system goes offline due to one or more of:
a hardware failure; and
a software failure.

24. The computing system of claim 19 wherein maintaining a block-layer, active-active relationship between the first site and the second site within the storage system includes:
processing read requests received by the first site on the first site; and
processing read requests received by the second site on the second site.

25. The computing system of claim 24 wherein maintaining a block-layer, active-active relationship between the first site and the second site within the storage system includes:
processing write requests received by the first site on the second site; and
processing write requests received by the second site on the second site.

26. The computing system of claim 19 wherein maintaining an application-layer, active-active relationship between a first site and a second site within a storage system includes:
executing a file system; and
processing one or more file system commands chosen from the group consisting of: a create file command, a delete file command, a rename file command and a truncate file command.

27. The computing system of claim 19 wherein maintaining an application-layer, active-active relationship between a first site and a second site within a storage system includes:
executing a database; and
processing one or more database commands including a SQL command.
